(19) United States
(12) Patent Application Publication
(10) Pub. No.: US 2006/0277095 A1
(43) Pub. Date: Dec. 7, 2006

(54) Citydex

(76) Inventor: Gil R. Tuinenburg, San Clemente, CA (US)

Correspondence Address: GIL TUINENBORG, 2 CAVE VISTA DEL SOL, SAN CLEMENTE, CA, 92673, US

(21) Appl. No.: 11/063,150

(22) Filed: Feb. 23, 2005

(51) Int. Cl. G06Q 30/00

(52) U.S. Cl. 705/14

(57) ABSTRACT

The advertisement is first printed and then die-cutted to size, then collated in specific order in preparation for shrink wrap. Once printed, die-cutted and collated the advertisement cards are shrink wrapped. Then the shrink wrapped advertisement cards are placed with the “Citydex” (plastic molded card holder) and placed into a plastic bag for delivery. The following process is the product is sent to a courier service for them to hand deliver the product to 10,000 homes/residences at a time. Citydex does not use United States postal service or any other sort of direct mailing services to deliver its product. Citydex delivers its product 3 to 4 times per year in various cities in California and plans to expand into other cities throughout the United States.

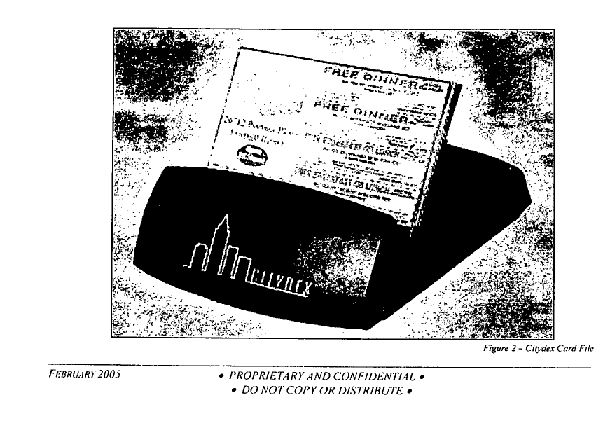

### BACKGROUND

Citydex started its business venture in March of 2003 in Winchester, Calif. Rick Tuinenburg founded the company. Around that time, Rick was shown a prototype of a very low cost card file system made of molded plastic. He recognized the opportunity to use that file to change the way advertisers reach consumers by giving those files to consumers filled with coupons and other promotional material. While operating his web development company, Rick continued to investigate the idea, having his own prototype produced in May of 2003, completing the draft version of sales literature in November, and producing a test run of files and card in December of the year. However, Rick realized that to make his vision a reality he would need someone with additional sales, marketing, and finance experience. His Brother Gil Tuinenburg took over the project and rights in August of 2004 and the company began more serious development including the creation of the business plan to guide their efforts.

Citydex have taken the idea and conducted case studies on local merchants and consumers to see if the product would be something that they would use. We have found that Citydex is a new way of getting advertisers more exposure and longer shelf life and found that consumers are less likely to throw away the product than the competition.

### DESCRIPTION

Citydex delivers an innovative new market tool directly to the doorstep of target consumers. The Citydex card file holds a small 3.5″×5″ sized coupons and promotional material in an attractive sleek molded plastic case. In addition to the coupons, the card file hold local contact information for the police, fire department, and a mini-calendar of local events motivating consumer to leave the card file nears their phone and in plain sight. This gives the advertisers a much better chance of influencing the buying behavior of those consumers while it minimizes the clutter in the consumer's living area. The card file holder itself is a small single piece of molded plastic. It is extremely durable but also quite attractive with the simple low-key logo on the front.

The card file is designed to hold up to 200 3.5″×5″ sized cards and allow users to flip through those cards very quickly and easily. In many ways, the card file is a very simple version of the classic Rolodex, which businesses have long used to organize telephone and address information. However, Citydex is strictly used for advertising purposes for local businesses and general local information. The vast majority of the cards will contain advertisements and valuable coupons from local merchants. These advertisements will be professionally designed and printed on high quality card stock using a deluxe four-color process. Since these coupons and advertisements will be neatly organized in the card file, consumers will be far more likely to keep them visible and accessible on a day-to-day basis compared with other advertising material.

Business Method (Process)

Citydex's business method is simply selling advertisements and promotional coupon cards for local merchants. Citydex provides consumers with an innovative sleek molded plastic cardholder with these advertisements/coupons and also local city information. Citydex provides these cardholders at no charge to our target consumers and our goal is to have consumers keep our product for at least 4 months until the new cardholder is delivered with updated information.

We deliver our product 3 times per year and we hand deliver our product and place them at the front door step of the consumers home. We do not use the mail system, since the product would not be cost effective.

1. A molded plastic case that holds 3.5′×5″ advertisement/promotional cards.
